(19) United States
(12) Patent Application Publication
(10) Pub. No.: US 2026/0290398 A1
(43) Pub. Date: Sep. 24, 2026

(54) RECORD SUPPORT PLATE, RECORD JACKET, AND RECORD PRODUCT

(71) Applicant: P-VINE, INC., Tokyo (JP)

(72) Inventors: Toshio MIZUTANI, Tokyo (JP); Mao YAMAZAKI, Tokyo (JP)

(21) Appl. No.: 18/998,013

(22) PCT Filed: Jul. 20, 2023
(86) PCT No.: PCT/JP2023/026513

§ 371 Date: Jan. 23, 2025

(30) Foreign Application Priority Data
Jul. 29, 2022 (JP) 2022-122061

(51) Int. Cl. G11B 23/03

(52) U.S. Cl. CPC G11B 23/0307; G11B 23/0313; G11B 23/032

(57) ABSTRACT

To accommodate a jacket for a 10-inch disc, a jacket for a 7-inch disc, or a jacket for a compact disc in a jacket for a 12-inch disc while preventing unnecessary movement that leads to damage. A record support plate (1) having a size corresponding to a 12-inch disc is used. In the record support plate (1), slits (11 through 17) are formed to fix a jacket (2). The jacket (2) is a jacket for a 10-inch disc, a jacket for a 7-inch disc, or a jacket for a compact disc. The record support plate (1) makes it possible to fix the jacket (2) to the record support plate (1) with the slits (11 through 17) without folding the record support plate (1).

### TECHNICAL FIELD

The present invention relates to a record support plate and a record jacket in which the record support plate is accommodated.

### BACKGROUND ART

Sound quality of analog records has been reevaluated, and demand for the analog records has increased rapidly in recent years. Analog records are classified into 12-inch discs, 10-inch discs, and 7-inch discs according to sizes thereof. 12-inch discs are mainly used as LP records, 10-inch discs are mainly used as SP records, and 7-inch discs are mainly used as EP records or singles. Analog records are each transported or stored in a state of being accommodated in a record jacket. Examples of a document which discloses a structure of a record jacket include Non-Patent Literature 1.

### CITATION LIST

### [Non-Patent Literature 1]

Regarding Record Jackets [searched on June 29, 2022], Internet <URL: http://analog.aprilrecords.jp/jacket/>

### SUMMARY OF INVENTION

### Technical Problem

A box for transporting an analog record and a shelf for storing analog records are designed and manufactured to suitably store a jacket for a 12-inch disc. Therefore, a jacket for a disc smaller than 12 inches (hereinafter, also referred to as “small disc”) is difficult to handle, as compared with a jacket for a 12-inch disc. As compared with a jacket for a 12-inch disc, a jacket for a small disc is less likely to give an owner a feeling of satisfaction attained by possession.

In order to solve such a problem, it is conceivable to accommodate a jacket for a small disc in a jacket for a 12-inch disc. Thus, it is expected that handling of the jacket for a small disc will be as easy as the jacket for a 12-inch disc. Moreover, it is expected that a feeling of satisfaction attained by possession of the jacket for a small disc will increase to a level equivalent to that of the jacket for a 12-inch disc.

However, in a case where a jacket for a small disc is accommodated in a jacket for a 12-inch disc, there arises a problem that the jacket for a small disc unnecessarily moves in the jacket for a 12-inch disc, and a corner of the jacket for a small disc is crushed or an edge of the jacket for a 12-inch disc is broken. A similar problem arises also in a case where a jacket for a compact disc (a so-called paper jacket) is accommodated in a jacket for a 12-inch disc.

An aspect of the present invention is accomplished in view of the above problems, and an object thereof is to realize a technique for accommodating a jacket for a 10-inch disc, a jacket for a 7-inch disc, or a jacket for a compact disc in a jacket for a 12-inch disc while preventing unnecessary movement that leads to damage.

### Solution to Problem

A record support plate in accordance with an aspect 1 of the present invention is a record support plate having a size corresponding to a 12-inch disc, in which: a slit for fixing a jacket for a 10-inch disc, a jacket for a 7-inch disc, or a jacket for a compact disc is formed in the record support plate; and the slit enables fixation of the jacket to the record support plate without folding of the record support plate.

According to the above configuration, the jacket (for a 10-inch disc, for a 7-inch disc, or for a compact disc) is fixed to the record support plate, and thus the jacket can be accommodated in a jacket for a 12-inch disc while preventing unnecessary movement that leads to damage. The slit is provided for the purpose of fixing the jacket. Note, however, that the slit can also be used to directly fix an inner sleeve for a 10-inch disc, a 7-inch disc, or a compact disc without disposing the jacket therebetween. This is because inner sleeves for a 10-inch disc, a 7-inch disc, and a compact disc have shapes and sizes which are substantially same as jackets for a 10-inch disc, a 7-inch disc, and a compact disc, respectively.

The record support plate in accordance with an aspect 2 of the present invention employs, in addition to the configuration of the aspect 1, a configuration in which: the slit includes (1) a first slit that prevents the jacket from moving in a first direction and that has both ends which abut on a first side of the jacket and (2) a second slit that prevents the jacket from moving in a second direction perpendicular to the first direction and in a direction opposite to the first direction and that has one end which abuts on a second side of the jacket and has the other end which abuts on a third side of the jacket, the second side being adjacent to the first side, and the third side being opposite to the first side.

According to the above configuration, it is possible to accommodate the jacket in a jacket for a 12-inch disc while preventing the jacket from moving in the first direction, the second direction, and the direction opposite to the first direction. Moreover, by moving the jacket in a direction opposite to the second direction, it is possible to easily detach the jacket from the record support plate.

The record support plate in accordance with an aspect 3 of the present invention employs, in addition to the configuration of the aspect 2, a configuration in which: the first slit is formed along (1) a line segment L11 perpendicular to the first direction, (2) a line segment L12 which extends in a direction away from a center of the record support plate from an end point of the line segment L11 at a second direction side and intersects with the line segment L11 at an obtuse angle, and (3) a line segment L13 which extends in a direction away from the center of the record support plate from an end point of the line segment L11 at a side opposite to the second direction side and intersects with the line segment L11 at an obtuse angle; and the second slit is formed along (1) a line segment L21 perpendicular to the first direction and (2) a line segment L22 which extends in a direction away from the center of the record support plate from an end point of the line segment L12 at the side opposite to the second direction side and intersects with the line segment L21 at an obtuse angle.

According to the above configuration, it is possible to accommodate the jacket in a jacket for a 12-inch disc while preventing the jacket from moving in the first direction, the second direction, and the direction opposite to the first direction. Moreover, by moving the jacket in a direction opposite to the second direction, it is possible to easily detach the jacket from the record support plate.

The record support plate in accordance with an aspect 4 of the present invention employs, in addition to the configuration of the aspect 1, a configuration in which: the slit includes (1) a first slit that prevents the jacket from moving in a first direction and that has both ends which abut on a first side of the jacket, (2) a second slit that prevents the jacket from moving in a second direction perpendicular to the first direction and that has both ends which abut on a second side of the jacket, the second side being adjacent to the first side, and (3) a third slit that prevents the jacket from moving in a direction opposite to the first direction and that has both ends which abut on a third side of the jacket, the third side being opposite to the first side.

According to the above configuration, it is possible to accommodate the jacket in a jacket for a 12-inch disc while preventing the jacket from moving in the first direction, the second direction, and the direction opposite to the first direction. Moreover, by moving the jacket in a direction opposite to the second direction, it is possible to easily detach the jacket from the record support plate.

The record support plate in accordance with an aspect 5 of the present invention employs, in addition to the configuration of the aspect 1, a configuration in which: the slit includes (1) a first slit that prevents the jacket from moving in a first direction and in a second direction perpendicular to the first direction and that has one end which abuts on a first side of the jacket and the other end which abuts on a second side of the jacket, the second side being adjacent to the first side and (2) a second slit that prevents the jacket from moving in the first direction and in a direction opposite to the second direction and that has one end which abuts on the first side of the jacket and the other end which abuts on a third side of the jacket, the third side being opposite to the second side.

According to the above configuration, it is possible to accommodate the jacket in a jacket for a 12-inch disc while preventing the jacket from moving in the first direction, the second direction, and the direction opposite to the first direction. Moreover, by moving the jacket in a direction opposite to the second direction, it is possible to easily detach the jacket from the record support plate.

The record support plate in accordance with an aspect 6 of the present invention employs, in addition to the configuration of any one of the aspects 1 through 5, a configuration in which: a shape in a plan view of the record support plate is a square shape or a rectangular shape in which a longitudinal length is 280 mm or more and 320 mm or less and a transverse length is 280 mm or more and 320 mm or less.

According to the above configuration, the jacket (the jacket for a 10-inch disc, the jacket for a 7-inch disc, or the jacket for a compact disc) is fixed to the record support plate, and thus the jacket can be accommodated in a jacket for a 12-inch disc while preventing unnecessary movement that leads to damage.

The record support plate in accordance with an aspect 7 of the present invention employs, in addition to the configurations of the aspects 1 through 6, a configuration in which: a circular hole is formed at one end or at each of both ends of the slit.

According to the above configuration, it is possible to reduce a possibility of a crack(s) occurring in the record support plate from one end or both ends of the slit.

A record jacket in accordance with an aspect 8 of the present invention includes: at least one sleeve capable of accommodating a 12-inch disc; and the record support plate described in any one of the aspects 1 through 7, the record support plate being accommodated in the sleeve.

According to the above configuration, it is possible to realize a record jacket for a 12-inch disc that is capable of accommodating the foregoing jacket.

A record product in accordance with an aspect 9 of the present invention includes: the record jacket described in the aspect 8; the jacket which is fixed to the record support plate; and the 10-inch disc, the 7-inch disc, or the compact disc which is accommodated in the jacket.

According to the above configuration, in possession of a 10-inch disc, a 7-inch disc, a compact disc, a jacket for a 10-inch disc, a jacket for a 7-inch disc, or a jacket for a compact disc, it is possible to realize a feeling of satisfaction that is similar to that attained by possession of a record jacket for a 12-inch disc.

A record jacket in accordance with an aspect 10 of the present invention includes: a sleeve having a size corresponding to a 12-inch disc, the sleeve having a first side which is sealed, a second side which is perpendicular to the first side and sealed, a third side which is perpendicular to the second side, parallel to the first side, and sealed, and a fourth side which is perpendicular to the third side and the first side, parallel to the second side, and opened; a record support plate having a size corresponding to a 12-inch disc, the record support plate having a first side, a second side perpendicular to the first side, a third side which is perpendicular to the second side and parallel to the first side, and a fourth side which is perpendicular to the third side and the first side and parallel to the second side; and a bag having a size corresponding to a 10-inch disc, a size corresponding to a 7-inch disc, or a size corresponding to a compact disc, the bag having a first side which is sealed, a second side which is perpendicular to the first side and sealed, a third side which is perpendicular to the second side, parallel to the first side, and opened, and a fourth side which is perpendicular to the third side and the first side, parallel to the second side, and sealed, the bag being attached to a main surface of the record support plate so that (1) a direction from the first side of the record support plate toward the third side of the record support plate conforms to a direction from the first side of the bag toward the third side of the bag, and a direction from the second side of the record support plate toward the fourth side of the record support plate conforms to a direction from the second side of the bag toward the fourth side of the bag and (2) a distance from the third side of the bag to the third side of the record support plate is smaller than a diameter of a disc accommodated in the bag, and in a case where the record support plate is accommodated in the sleeve so that a direction from the first side of the record support plate toward the third side of the record support plate conforms to a direction from the first side of the sleeve toward the third side of the sleeve and a direction from the second side of the record support plate toward the fourth side of the record support plate conforms to a direction from the second side of the sleeve toward the fourth side of the sleeve, a position of the disc accommodated in the bag being restricted from four directions by the first side, the second side, and the fourth side of the bag and the third side of the sleeve.

According to the above configuration, it is possible to realize a record jacket for a 12-inch disc that is capable of accommodating, in the bag, a 10-inch disc, a 7-inch disc, a compact disc, a jacket for a 10-inch disc, a jacket for a 7-inch disc, or a jacket for a compact disc without free movement.

A record product in accordance with an aspect 11 of the present invention includes: the record jacket described in the aspect 10; and the 10-inch disc, the 7-inch disc, or the compact disc which is accommodated in the record jacket.

According to the above configuration, in possession of a 10-inch disc, a 7-inch disc, a compact disc, a jacket for a 10-inch disc, a jacket for a 7-inch disc, or a jacket for a compact disc, it is possible to realize a feeling of satisfaction that is similar to that attained by possession of a record jacket for a 12-inch disc.

### Advantageous Effects of Invention

According to an aspect of the present invention, it is possible to accommodate a jacket for a 10-inch disc, a jacket for a 7-inch disc, or a jacket for a compact disc in a jacket for a 12-inch disc while preventing unnecessary movement that

### BRIEF DESCRIPTION OF DRAWINGS

FIG. 1 is a perspective view illustrating a configuration of a record support plate in accordance with Embodiment 1 of the present invention.

FIG. 2 is a three-view drawing illustrating a configuration of the record support plate illustrated in FIG. 1.

FIG. 3 is a perspective view illustrating a configuration of a record jacket in which the record support plate illustrated in FIG. 1 is accommodated.

FIG. 4 is a three-view drawing illustrating a configuration of a record support plate in accordance with Embodiment 2 of the present invention.

FIG. 5 is a three-view drawing illustrating a configuration of a record support plate in accordance with Embodiment 3 of the present invention.

FIG. 6 is a perspective view illustrating a configuration of a record jacket in accordance with Embodiment 4 of the present invention, and a plan view illustrating a relation between an image printed on a bag and an image printed on a record support plate.

### Embodiment 1

### Configuration of Record Support Plate

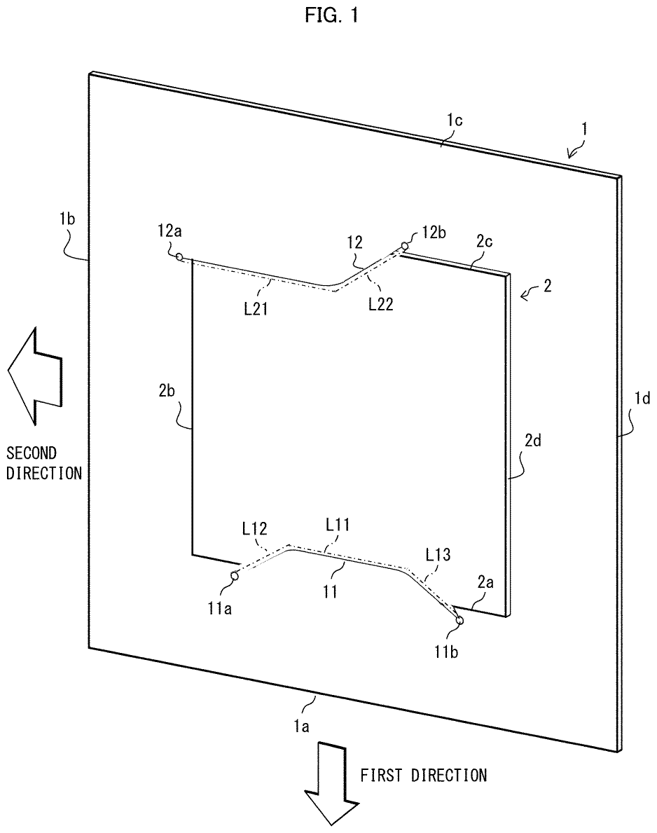

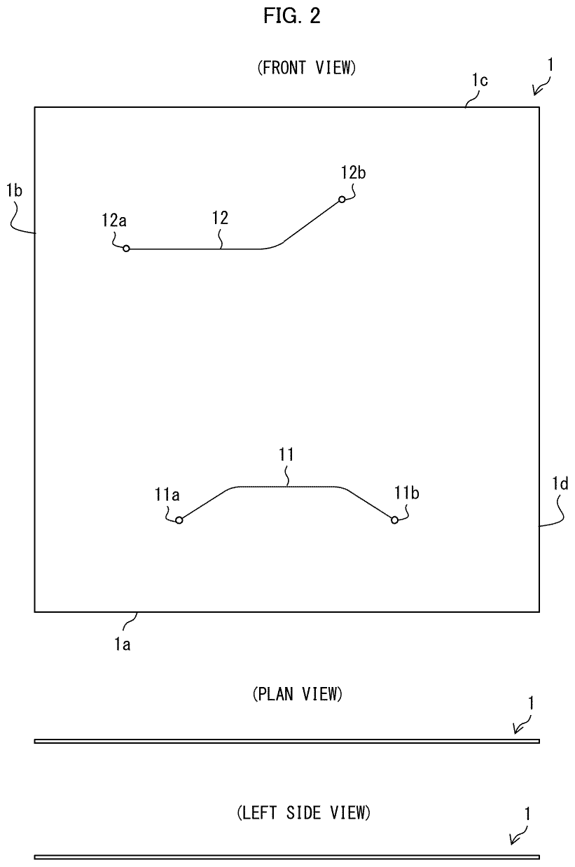

The following description will discuss a configuration of a record support plate 1 in accordance with Embodiment 1 of the present invention, with reference to FIGS. 1 and 2. FIG. 1 is a perspective view illustrating the configuration of the record support plate 1. FIG. 2 is a three-view drawing illustrating the configuration of the record support plate 1. Note that a back surface of the record support plate 1 is symmetrical to a front surface of the record support plate 1 shown in a front view of FIG. 2. A left side surface of the record support plate 1 is symmetrical to a right side surface of the record support plate 1 shown in a right side view of FIG. 2. A bottom surface of the record support plate 1 is symmetrical to a top surface of the record support plate 1 shown in a plan view of FIG. 2. Therefore, the back surface, the left side surface, and the bottom surface of the record support plate 1 are not illustrated in FIGS. 1 and 2.

The record support plate 1 is a plate-like member having a size corresponding to a 12-inch disc. In the present embodiment, a plate-like member having a front view shape that is a square shape or a rectangular shape in which a longitudinal length is 280 mm or more and 320 mm or less and a transverse length is 280 mm or more and 320 mm or less is used as the record support plate 1. A thickness of the record support plate 1 is not particularly limited and is, for example, 0.5 mm or more and 5 mm or less. A material of the record support plate 1 is not particularly limited and is, for example, paper or plastic. Artwork may be printed on one or both of the front surface and the back surface of the record support plate 1.

Two slits 11 and 12 for fixing a jacket 2 are formed in the record support plate 1. In the present embodiment, the jacket 2 is assumed to be a jacket for a 7-inch disc. Note, however, that the jacket 2 is not limited to a jacket for a 7-inch disc. The jacket 2 may be a jacket for a 10-inch disc or a paper jacket for a compact disc.

The first slit 11 is a slit for preventing the jacket 2 from moving in a first direction (downward direction in FIG. 1). In the present embodiment, as the first slit 11, a U-shaped slit formed along a line segment L11, a line segment L12, and a line segment L13 is used. Here, the line segment L11 is perpendicular to the first direction. The line segment L12 extends in a direction away from a center of the record support plate 1 from an end point of the first line segment L11 at a second direction side, and intersects with the first line segment L11 at an obtuse angle. The line segment L13 extends in a direction away from the center of the record support plate 1 from an end point of the first line segment L11 at a side opposite to the second direction side, and intersects with the line segment L11 at an obtuse angle.

The second slit 12 is a slit for preventing the jacket 2 from moving in a second direction (leftward direction in FIG. 1) perpendicular to the first direction and in a direction (upward direction in FIG. 1) opposite to the first direction. In the present embodiment, as the second slit 12, a slit is used which is formed along a line segment L21 and a line segment L22 with a bend therebetween. Here, the line segment L21 is perpendicular to the first direction. The line segment L22 extends in a direction away from the center of the record support plate 1 from an end point of the line segment L21 at a side opposite to the second direction side, and intersects with the line segment L21 at an obtuse angle.

The jacket 2 is fixed to the record support plate 1 such that a central part of a first side 2a (lower side in FIG. 1) enters a back side of a tongue piece which is surrounded by the first slit 11 in three directions and a corner part between a second side 2b (left side in FIG. 1) and a third side 2c (upper side in FIG. 1) of the jacket 2 enters a back side of a tongue piece which is surrounded by the second slit 12 in two directions. Here, the second side 2b is perpendicular to the first side 2a, and the third side 2c is opposite to the first side 2a. In this case, both ends 11a and 11b of the first slit 11 abut on the first side 2a of the jacket 2. Moreover, one end 12a of the second slit 12 abuts on the second side 2b of the jacket 2, and the other end 12b of the second slit 12 abuts on the third side 2c of the jacket 2. Fixation of the jacket 2 to the record support plate 1 can be easily released by sliding the jacket 2 in a direction opposite to the second direction.

Circular holes are formed at the both ends 11a and 11b of the first slit 11. With the configuration, it is possible to reduce a possibility of cracks occurring in the record support plate 1 from the both ends 11a and 11b of the first slit 11 due to contact of the first side 2a of the jacket 2. Similarly, circular holes are formed at both ends 12a and 12b of the second slit 12. Thus, it is possible to reduce a possibility of a crack occurring in the record support plate 1 from the one end 12a of the second slit 12 due to contact of the second side 2b of the jacket 2 and a possibility of a crack occurring in the record support plate 1 from the other end 12b of the second slit 12 due to contact of the third side 2c of the jacket 2. In a case where a material (e.g., plastic) in which a crack is less likely to occur is selected as a material of the record support plate 1, the circular holes may be omitted.

By using the record support plate 1 in accordance with the present embodiment, it is possible to accommodate the jacket 2 in a jacket for a 12-inch disc, put the jacket 2 in a box for transporting a 12-inch disc, and put the jacket 2 in a shelf for storing 12-inch discs. In such a case, the jacket 2 is fixed to the record support plate 1, and it is therefore possible to reduce a possibility that the jacket 2 moves in the jacket, the jacket 2 moves in the box, and the jacket 2 moves in the shelf. As a result, it is possible to reduce a possibility of damage to the jacket 2 or a 7-inch disc accommodated in the jacket 2. In a case where the jacket 2 is accommodated in a jacket for a 12-inch disc, it is possible to increase a feeling of satisfaction attained by possession of a 7-inch disc to a level equivalent to a feeling of satisfaction attained by possession of a 12-inch disc.

Note that the record support plate 1 may be used so that (1) the first direction conforms to the gravitational direction, (2) the second direction conforms to the gravitational direction, or (3) the direction opposite to the first direction conforms to the gravitational direction. In any of the cases, it is possible to prevent the jacket 2 from sliding in the direction opposite to the second direction by the gravity, and consequently prevent the jacket 2 from falling off the record support plate 1. In particular, in a case where the first direction conforms to the gravitational direction, a load caused due to a weight of the jacket 2 can be dispersed to both the ends 11a and 11b of the slit 11. Therefore, it is possible to minimize a possibility of a crack occurring in the record support plate 1.

### Configuration of Record Jacket

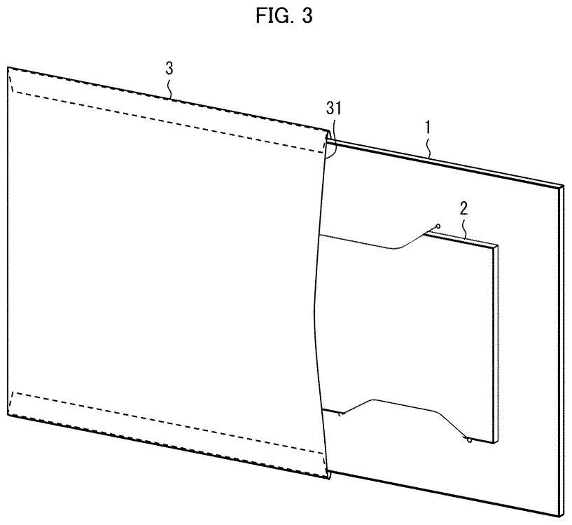

The following description will discuss a configuration of a record jacket 3 in which the record support plate 1 is accommodated, with reference to FIG. 3. FIG. 3 is a perspective view illustrating the configuration of the record jacket 3.

The record jacket 3 includes a sleeve 31 which is capable of accommodating a 12-inch disc. The record support plate 1 is accommodated in the sleeve 31. Thus, it is possible to accommodate the jacket 2 in the record jacket 3 without free movement.

Note that the record jacket 3 may have two or more sleeves. In such a case, for example, a 12-inch disc can be accommodated in a sleeve other than the sleeve that accommodates the record support plate 1. This makes it possible to realize a record jacket 3 that can simultaneously accommodate a 12-inch disc and a disc (a 10-inch disc, a 7-inch disc, or a compact disc) smaller than a 12-inch disc. For example, in a record jacket of a gatefold type having two sleeves, a usage aspect is conceivable in which a 12-inch disc is accommodated in one sleeve and a disc smaller than a 12-inch disc is accommodated in the other sleeve.

### Embodiment 2

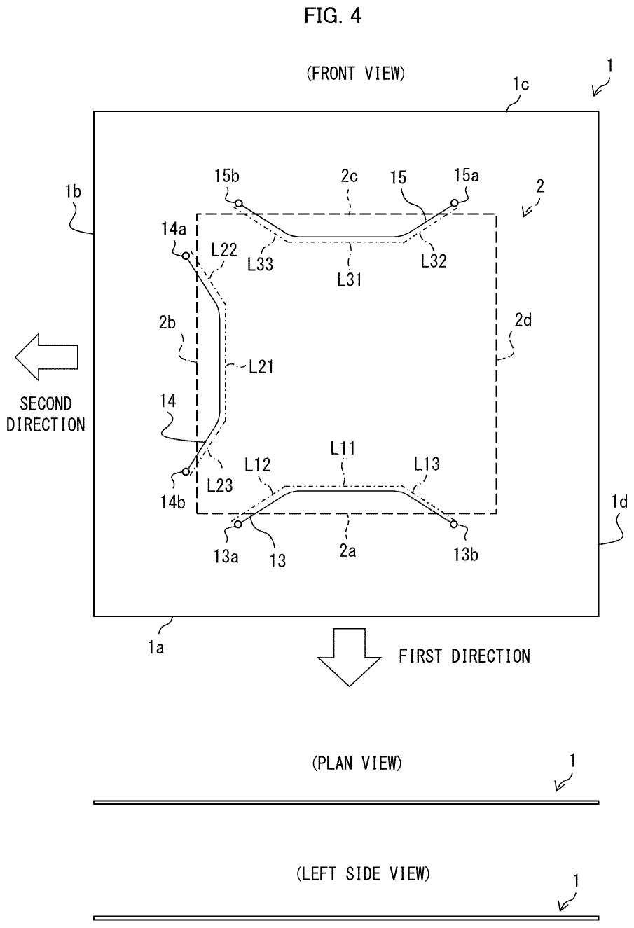

The following description will discuss a configuration of a record support plate 1 in accordance with Embodiment 2 of the present invention, with reference to FIG. 4. FIG. 4 is a three-view drawing illustrating the configuration of the record support plate 1 in accordance with the present embodiment.

The record support plate 1 in accordance with the present embodiment differs from the record support plate 1 in accordance with Embodiment 1 in that slits 13, 14, and 15 are formed in place of the slits 11 and 12. The following description will discuss the slits 13, 14, and 15. Note that a main effect brought about by the record support plate 1 in accordance with the present embodiment is similar to the effect brought about by the record support plate 1 in accordance with Embodiment 1.

The first slit 13 is a slit for preventing the jacket 2 from moving in a first direction (downward direction in FIG. 4). In the present embodiment, as the first slit 13, a U-shaped slit formed along a line segment L11, a line segment L12, and a line segment L13 is used. Here, the line segment L11 is perpendicular to the first direction. The line segment L12 extends in a direction away from a center of the record support plate 1 from an end point of the first line segment L11 at a second direction side, and intersects with the first line segment L11 at an obtuse angle. The line segment L13 extends in a direction away from the center of the record support plate 1 from an end point of the first line segment L11 at a side opposite to the second direction side, and intersects with the line segment L11 at an obtuse angle.

The second slit 14 is a slit for preventing the jacket 2 from moving in a second direction (leftward direction in FIG. 4) perpendicular to the first direction. In the present embodiment, as the second slit 14, a U-shaped slit formed along a line segment L21, a line segment L22, and a line segment L23 is used. Here, the line segment L21 is perpendicular to the second direction. The line segment L22 extends in a direction away from the center of the record support plate 1 from an end point of the first line segment L21 at a side opposite to the first direction side, and intersects with the first line segment L21 at an obtuse angle. The line segment L23 extends in a direction away from the center of the record support plate 1 from an end point of the first line segment L21 at the first direction side, and intersects with the line segment L21 at an obtuse angle.

The third slit 15 is a slit for preventing the jacket 2 from moving in a direction (upward direction in FIG. 4) opposite to the first direction. In the present embodiment, as the third slit 15, a U-shaped slit formed along a line segment L31, a line segment L32, and a line segment L33 is used. Here, the line segment L31 is perpendicular to the first direction. The line segment L32 extends in a direction away from the center of the record support plate 1 from an end point of the first line segment L31 at a side opposite to the second direction side, and intersects with the first line segment L31 at an obtuse angle. The line segment L33 extends in a direction away from the center of the record support plate 1 from an end point of the first line segment L31 at the second direction side, and intersects with the line segment L31 at an obtuse angle.

The jacket 2 is fixed to the record support plate 1 such that a central part of the first side 2a (lower side in FIG. 4) enters a back side of a tongue piece which is surrounded by the first slit 13 in three directions, a central part of the second side 2a (left side in FIG. 4) enters a back side of a tongue piece which is surrounded by the second slit 14 in three directions, and a central part of the third side 2c (upper side in FIG. 4) enters a back side of a tongue piece which is surrounded by the third slit 15 in three directions. Here, the second side 2b is perpendicular to the first side 2a, and the third side 2c is opposite to the first side 2a. In this case, both ends 13a and 13b of the first slit 13 abut on the first side 2a of the jacket 2. Moreover, both ends 14a and 14b of the second slit 14 abut on the second side 2b of the jacket 2. Moreover, both ends 15a and 15b of the third slit 15 abut on the third side 2c of the jacket 2. Fixation of the jacket 2 to the record support plate 1 can be easily released by sliding the jacket 2 in the direction opposite to the second direction.

Circular holes are formed at the both ends 13a and 13b of the first slit 13. With the configuration, it is possible to reduce a possibility of cracks occurring in the record support plate 1 from the both ends 13a and 13b of the first slit 13 due to contact of the first side 2a of the jacket 2. Moreover, circular holes are formed also at both ends 14a and 14b of the second slit 14. With the configuration, it is possible to reduce a possibility of cracks occurring in the record support plate 1 from the both ends 14a and 14b of the second slit 14 due to contact of the first side 2a of the jacket 2. Moreover, circular holes are formed also at both ends 15a and 15b of the third slit 15. With the configuration, it is possible to reduce a possibility of cracks occurring in the record support plate 1 from the both ends 15a and 15b of the third slit 15 due to contact of the third side 2c of the jacket 2. In a case where a material (e.g., plastic) in which a crack is less likely to occur is selected as a material of the record support plate 1, the circular holes may be omitted.

Note that the record support plate 1 may be used so that (1) the first direction conforms to the gravitational direction, (2) the second direction conforms to the gravitational direction, or (3) the direction opposite to the first direction conforms to the gravitational direction. In any of the cases, it is possible to prevent the jacket 2 from sliding in the direction opposite to the second direction by the gravity, and consequently prevent the jacket 2 from falling off the record support plate 1.

### Embodiment 3

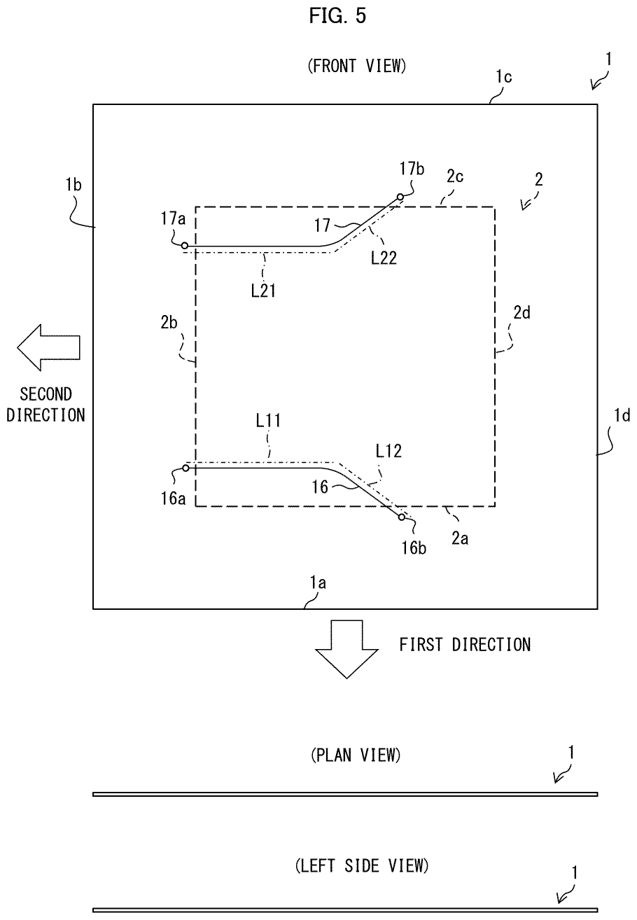

The following description will discuss a configuration of a record support plate 1 in accordance with Embodiment 3 of the present invention, with reference to FIG. 5. FIG. 5 is a three-view drawing illustrating the configuration of the record support plate 1 in accordance with the present embodiment.

The record support plate 1 in accordance with the present embodiment differs from the record support plate 1 in accordance with Embodiment 1 in that slits 16 and 17 are formed in place of the slits 11 and 12. The following description will discuss the slits 16 and 17. Note that a main effect brought about by the record support plate 1 in accordance with the present embodiment is similar to the effect brought about by the record support plate 1 in accordance with Embodiment 1.

The first slit 16 is a slit for preventing the jacket 2 from moving in a first direction (downward direction in FIG. 5) and in a second direction (leftward direction in FIG. 5) perpendicular to the first direction. In the present embodiment, as the first slit 16, a slit is used which is formed along a line segment L11 and a line segment L12 with a bend therebetween. Here, the line segment L11 is perpendicular to the first direction. The line segment L12 extends in a direction away from the center of the record support plate 1 from an end point of the line segment L11 at a side opposite to the second direction side, and intersects with the first line segment L11 at an obtuse angle.

The second slit 17 is a slit for preventing the jacket 2 from moving in a direction (upward direction in FIG. 5) opposite to the first direction and in the second direction (leftward direction in FIG. 5). In the present embodiment, as the second slit 17, a slit is used which is formed along a line segment L21 and a line segment L22 with a bend therebetween. Here, the line segment L21 is perpendicular to the first direction. The line segment L22 extends in a direction away from the center of the record support plate 1 from an end point of the first line segment L21 at a side opposite to the second direction side, and intersects with the first line segment L21 at an obtuse angle.

The jacket 2 is fixed to the record support plate 1 such that a corner part between a first side 2a (lower side in FIG. 5) and a second side 2b (left side in FIG. 5) enters a back side of a tongue piece which is surrounded by the first slit 16 in two directions and a corner part between a third side 2c (upper side in FIG. 5) and the second side 2b enters a back side of a tongue piece which is surrounded by the second slit 17 in two directions. Here, the second side 2b is perpendicular to the first side 2a, and the third side 2c is opposite to the first side 2a. In this case, one end 16a of the first slit 16 abuts on the second side 2b of the jacket 2, and the other end 16b of the first slit 16 abuts on the first side 2a of the jacket 2. Moreover, one end 17a of the second slit 17 abuts on the second side 2b of the jacket 2, and the other end 17b of the second slit 17 abuts on the third side 2c of the jacket 2. Fixation of the jacket 2 to the record support plate 1 can be easily released by sliding the jacket 2 in the direction opposite to the second direction.

Circular holes are formed at both the ends 16a and 16b of the first slit 16. Thus, it is possible to reduce a possibility of a crack occurring in the record support plate 1 from the one end 16a of the first slit 16 due to contact of the second side 2b of the jacket 2 and a possibility of a crack occurring in the record support plate 1 from the other end 16b of the first slit 16 due to contact of the first side 2a of the jacket 2. Moreover, circular holes are formed at both the ends 17a and 17b of the second slit 17. Thus, it is possible to reduce a possibility of a crack occurring in the record support plate 1 from the one end 17a of the second slit 17 due to contact of the second side 2b of the jacket 2 and a possibility of a crack occurring in the record support plate 1 from the other end 17b of the second slit 17 due to contact of the third side 2c of the jacket 2. In a case where a material (e.g., plastic) in which a crack is less likely to occur is selected as a material of the record support plate 1, the circular holes may be omitted.

Note that the record support plate 1 may be used so that (1) the first direction conforms to the gravitational direction, (2) the second direction conforms to the gravitational direction, or (3) the direction opposite to the first direction conforms to the gravitational direction. In any of the cases, it is possible to prevent the jacket 2 from sliding in the direction opposite to the second direction by the gravity, and consequently prevent the jacket 2 from falling off the record support plate 1. In particular, in a case where the second direction conforms to the gravitational direction, a load caused due to a weight of the jacket 2 can be dispersed to the end 16a of the first slit 16 and the end 17a of the second slit 17. Therefore, it is possible to minimize a possibility of a crack occurring in the record support plate 1.

### Additional Remarks

In the above described Embodiments 1 through 3, the slits 11 through 17 formed in the record support plate 1 are provided for the purpose of fixing a jacket for a 7-inch disc, a 10-inch disc, or a compact disc. Note, however, that the slits 11 through 17 can also be used to fix an inner sleeve (e.g., a bag made of paper in which a circular hole is formed in the center) for a 7-inch disc, a 10-inch disc, or a compact disc. This is because an inner sleeve for a 7-inch disc has substantially the same shape and size as those of a jacket for a 7-inch disc, an inner sleeve for a 10-inch disc has substantially the same shape and size as those of a jacket for a 10-inch disc, and an inner sleeve for a compact disc has substantially the same shape and size as those of a jacket for a compact disc.

It should also be noted that, in the above described Embodiments 1 through 3, it is possible to fix the jacket 2 to the record support plate 1 with the slits 11 through 17 without folding the record support plate 1, as understood from FIGS. 1, 3, 4, and 5. With this structure, when the record support plate 1 is accommodated in the sleeve 31, for example, a situation does not occur in which a part of a folded ear is caught in an entrance of the sleeve 31, and insertion can be easily made.

### Embodiment 4

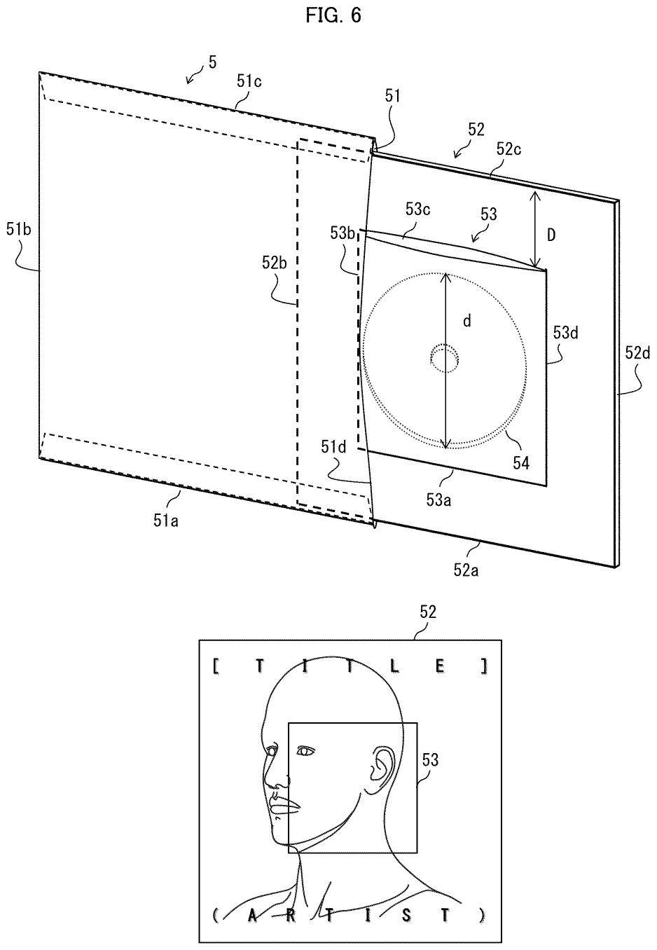

The following description will discuss a configuration of a record jacket 5 in accordance with Embodiment 4 of the present invention, with reference to FIG. 6. FIG. 6 is a perspective view illustrating a configuration of the record jacket 5 in accordance with Embodiment 4 of the present invention, and a plan view illustrating a relation between an image printed on a bag 4 and an image printed on a record support plate 1′.

The record jacket 5 includes a sleeve 51 having a size corresponding to a 12-inch disc, a record support plate 52 having a size corresponding to a 12-inch disc, and a bag 53 having a size corresponding to a 10-inch disc, a size corresponding to a 7-inch disc, or a size corresponding to a compact disc. A product in which a disc 54 is accommodated in the bag 53 is to be distributed as a record product. In a case where the disc 54 is a 10-inch disc, a bag having a size corresponding to a 10-inch disc is used as the bag 53. In a case where the disc 54 is a 7-inch disc, a bag having a size corresponding to a 7-inch disc is used as the bag 53. In a case where the disc 54 is a compact disc, a bag having a size corresponding to a compact disc is used as the bag 53. A bare disc 54 may be accommodated in the bag 53, or a disc 54 accommodated in an inner sleeve may be accommodated in the bag 53.

The sleeve 51 is a bag-shaped member and has (1) a sealed first side 51a, (2) a second side 51b which is perpendicular to the first side 51a and sealed, (3) a third side 51c which is perpendicular to the second side 51b, parallel to the first side 51a, and sealed, and (4) a fourth side 51d which is perpendicular to the third side 51c and the first side 51a, parallel to the second side 51b, and opened.

The record support plate 52 is a plate-like member and has (1) a first side 52a, (2) a second side 52b perpendicular to the first side 52a, (3) a third side 52c perpendicular to the second side 52b and parallel to the first side 52a, and (4) a fourth side 52d perpendicular to the third side 52c and the first side 52a and parallel to the second side 52b. A shape, a size, a material, and the like of the record support plate 52 are similar to those of the record support plate 1 described above.

The record support plate 52 is accommodated in the sleeve 51 such that (a) a direction from the first side 52a of the record support plate 52 toward the third side 52c of the record support plate 52 conforms to a direction from the first side 51a of the sleeve 51 toward the third side 51c of the sleeve 51, and (b) a direction from the second side 52b of the record support plate 52 toward the fourth side 52d of the record support plate 52 conforms to a direction from the second side 51b of the sleeve 51 toward the fourth side 51d of the sleeve 51.

The bag 53 is a bag-like member and has (1) a sealed first side 53a, (2) a second side 53b which is perpendicular to the first side 53a and sealed, (3) a third side 53c which is perpendicular to the second side 53b, parallel to the first side 53a, and opened, and (4) a fourth side 53d which is perpendicular to the third side 53c and the first side 53a, parallel to the second side 53b, and sealed. The bag 53 may be constituted by a transparent material such as vinyl or an opaque material such as paper.

The bag 53 is attached to a main surface of the record support plate 52 such that (1a) a direction from the first side 52a of the record support plate 52 toward the third side 52c of the record support plate 52 conforms to a direction from the first side 53a of the bag 53 toward the third side 53c of the bag 53, (1b) a direction from the second side 52b of the record support plate 52 toward the fourth side 52d of the record support plate 52 conforms to a direction from the second side 53b of the bag 53 toward the fourth side 53d of the bag 53, and (2a) a distance D from the third side 53c of the bag 53 to the third side 52c of the record support plate 52 is smaller than a diameter d of the disc 54 which is accommodated in the bag 54.

With the above structure, a position of the disc 54 accommodated in the bag 54 is restricted from four directions by the first side 53a, the second side 53b, and the fourth side 53d of the bag 53 and the third side 51c of the sleeve 51. Thus, as long as the record support plate 52 is accommodated in the sleeve 51, it is possible to prevent the disc 54 accommodated in the bag 53 from coming out of the bag 53. Therefore, it is not necessary to worry that the disc 54 which has come out of the bag 53 damages the sleeve 51 or the disc 54 falls off the sleeve 51 and is damaged.

Note that artwork may be printed on the record support plate 52 and the bag 53. In such a case, it is preferable that the bag 53 is attached to the main surface of the record support plate 52 so that, as illustrated in the lower part of FIG. 6, an image printed on the bag 53 and an image printed on the record support plate 1 are sequential images having no deviation and constituting a single image.

### Additional Remarks

The present invention is not limited to the embodiments described above, but may be altered in various ways by a skilled person within the scope of the claims. Any embodiment based on a proper combination of technical means disclosed in different embodiments is also encompassed in the technical scope of the present invention.

### REFERENCE SIGNS LIST

11 through 17: Slit
2: Jacket (for a 10-inch disc, a 7-inch disc, or a compact disc)
3: Record jacket (for a 12-inch disc)
5: Record jacket
51: Sleeve
52: Record support plate
53: Bag

1. A record support plate having a size corresponding to a 12-inch disc, wherein:
a slit for fixing a jacket for a 10-inch disc, a jacket for a 7-inch disc, or a jacket for a compact disc is formed in said record support plate; and
the slit enables fixation of the jacket to said record support plate without folding of said record support plate.

2. The record support plate as set forth in claim 1, wherein:
the slit includes (1) a first slit that prevents the jacket from moving in a first direction and that has both ends which abut on a first side of the jacket and (2) a second slit that prevents the jacket from moving in a second direction perpendicular to the first direction and in a direction opposite to the first direction and that has one end which abuts on a second side of the jacket and has the other end which abuts on a third side of the jacket, the second side being adjacent to the first side, and the third side being opposite to the first side.

3. The record support plate as set forth in claim 2, wherein:
the first slit is formed along (1) a line segment L11 perpendicular to the first direction, (2) a line segment L12 which extends in a direction away from a center of said record support plate from an end point of the line segment L11 at a second direction side and intersects with the line segment L11 at an obtuse angle, and (3) a line segment L13 which extends in a direction away from the center of said record support plate from an end point of the line segment L11 at a side opposite to the second direction side and intersects with the line segment L11 at an obtuse angle; and
the second slit is formed along (1) a line segment L21 perpendicular to the first direction and (2) a line segment L22 which extends in a direction away from the center of said record support plate from an end point of the line segment L12 at the side opposite to the second direction side and intersects with the line segment L21 at an obtuse angle.

4. The record support plate as set forth in claim 1, wherein:
the slit includes (1) a first slit that prevents the jacket from moving in a first direction and that has both ends which abut on a first side of the jacket, (2) a second slit that prevents the jacket from moving in a second direction perpendicular to the first direction and that has both ends which abut on a second side of the jacket, the second side being adjacent to the first side, and (3) a third slit that prevents the jacket from moving in a direction opposite to the first direction and that has both ends which abut on a third side of the jacket, the third side being opposite to the first side.

5. The record support plate as set forth in claim 1, wherein:
the slit includes (1) a first slit that prevents the jacket from moving in a first direction and in a second direction perpendicular to the first direction and that has one end which abuts on a first side of the jacket and the other end which abuts on a second side of the jacket, the second side being adjacent to the first side and (2) a second slit that prevents the jacket from moving in the first direction and in a direction opposite to the second direction and that has one end which abuts on the first side of the jacket and the other end which abuts on a third side of the jacket, the third side being opposite to the second side.

6. The record support plate as set forth in claim 1, wherein:
a shape in a plan view of said record support plate is a square shape or a rectangular shape in which a longitudinal length is 280 mm or more and 320 mm or less and a transverse length is 280 mm or more and 320 mm or less.

7. The record support plate as set forth in claim 1, wherein:
a circular hole is formed at one end or at each of both ends of the slit.

8. A record jacket, comprising:
at least one sleeve capable of accommodating a 12-inch disc; and
a record support plate recited in claim 1, the record support plate being accommodated in the sleeve.

9. A record product, comprising:
a record jacket recited in claim 8;
the jacket which is fixed to the record support plate; and
the 10-inch disc, the 7-inch disc, or the compact disc which is accommodated in the jacket.

10. A record jacket, comprising:
a sleeve having a size corresponding to a 12-inch disc, the sleeve having a first side which is sealed, a second side which is perpendicular to the first side and sealed, a third side which is perpendicular to the second side, parallel to the first side, and sealed, and a fourth side which is perpendicular to the third side and the first side, parallel to the second side, and opened;
a record support plate having a size corresponding to a 12-inch disc, the record support plate having a first side, a second side perpendicular to the first side, a third side which is perpendicular to the second side and parallel to the first side, and a fourth side which is perpendicular to the third side and the first side and parallel to the second side; and
a bag having a size corresponding to a 10-inch disc, a size corresponding to a 7-inch disc, or a size corresponding to a compact disc, the bag having a first side which is sealed, a second side which is perpendicular to the first side and sealed, a third side which is perpendicular to the second side, parallel to the first side, and opened, and a fourth side which is perpendicular to the third side and the first side, parallel to the second side, and sealed, the bag being attached to a main surface of the record support plate so that (1) a direction from the first side of the record support plate toward the third side of the record support plate conforms to a direction from the first side of the bag toward the third side of the bag, and a direction from the second side of the record support plate toward the fourth side of the record support plate conforms to a direction from the second side of the bag toward the fourth side of the bag and (2) a distance from the third side of the bag to the third side of the record support plate is smaller than a diameter of a disc accommodated in the bag, and
in a case where the record support plate is accommodated in the sleeve so that a direction from the first side of the record support plate toward the third side of the record support plate conforms to a direction from the first side of the sleeve toward the third side of the sleeve and a direction from the second side of the record support plate toward the fourth side of the record support plate conforms to a direction from the second side of the sleeve toward the fourth side of the sleeve, a position of the disc accommodated in the bag being restricted from four directions by the first side, the third side, and the fourth side of the bag and the second side of the sleeve.

11. A record product, comprising:
a record jacket recited in claim 10; and
the 10-inch disc, the 7-inch disc, or the compact disc which is accommodated in the record jacket.
